(19) United States
(12) Patent Application Publication
(10) Pub. No.: US 2004/0150846 A1
(43) Pub. Date: Aug. 5, 2004

(54) Color image halftoning apparatus and method, and mask generation apparatus and method used therein

(75) Inventor: Young-hoon Jeong, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/687,699

(22) Filed: Oct. 20, 2003

(30) Foreign Application Priority Data
Feb. 5, 2003 (KR) 2003-7119

(51) Int. Cl. H04N 1/52

(52) U.S. Cl. 358/1.9; 358/534; 358/3.23

(57) ABSTRACT

A color image halftoning apparatus and method for creating a color bilevel image from a color output device, and mask generation apparatus and method used in the color image halftoning apparatus and method are provided. The color image halftoning apparatus includes: an address generator that receives a pixel in an image intended for halftoning and generates an address corresponding to the position of the pixel in a mask memory storing mask threshold values for one color channel; a mask generator that receives a mask threshold corresponding to the address from the mask memory and generates a mask threshold value for each of a plurality of color channels; and a comparison unit that sequentially receives the mask threshold value generated for each of the plurality of color channels and the pixel value in the image intended for halftoning, compares both values, and outputs a bilevel value according to a predetermined rule.

This application claims priority from Korean Patent Application No. 2003-7119, filed on Feb. 5, 2003, the disclosure of which is incorporated herein in its entirety by reference.

### BACKGROUND OF THE INVENTION

1. Field of the Invention

The present invention relates to halftoning of color images, and more particularly, to a color image halftoning apparatus and method for creating a binary image from a color output device such as a color facsimile, a color printer, or a color digital copier, and mask generation apparatus and method used in the color image halftoning apparatus and method.

2. Description of the Related Art

Halftoning is the process of representing a continuous tone image as a bilevel image. During the halftoning process, the continuous tone image is transformed into a pattern of black dots. That is, a continuous tone image has a value between 0 and 255 which is mapped to an output image having 0 or 255. Then, each pixel in an output bilevel image is represented as a black or white dot. Thus, the halftone image looks like the original continuous tone image when it is viewed at a distance. The halftoning technique is used for laser printer, inkjet printer, facsimile, copier, or various display devices.

FIG. 1 explains a halftoning process. Referring to FIG. 1, a gray level image 110 having a continuous tone value is input to a halftoning unit 120. The halftoning unit 120 then carries out a halftoning process to generate a bilevel image 130. While the input gray level image 110 is a representation of continuous shades of gray, the output bilevel image 130 is represented by either ‘0’ or ‘1’. Thus, when looking closely at the bilevel image 130, a human viewer can perceive individual block patterns that look awkward, but at a distance the image looks continuous like the input gray level image 110.

FIG. 2 is an enlarged view of a bilevel image 210 generated by halftoning. Referring to FIG. 2, each printed pixel in the bilevel image 210 is represented by the presence or absence of a black dot, i.e., ‘0’ or ‘1’. When the image 210 is enlarged for close viewing, a viewer can see several block patterns as shown in FIG. 2. That is, halftoning is performed on an image 210 having a continuous tone value to generate the bilevel image 210, a portion 220 of which is enlarged to obtain the resulting 230.

Examples of this halftoning algorithm include simple threshold, dithering, error diffusion, and halftoning using a blue noise mask. Dithering is the method suitable for documents containing mainly images where each pixel in a continuous tone image is compared with a threshold value stored in a threshold matrix and one of both values is selected and output as a halftone value.

FIG. 3 shows input and output bilevel images for explaining halftoning using a mask. That is, as shown in FIG. 3, a butterfly image 310 is input and undergoes halftoning by passing a mask 320 consisting of an array of pixels, and a halftoned image 330 is processed in a printer or fax for printing.

There are many methods for digital halftoning. In particular, halftoning using a mask or masking method involves comparing a currently input continuous tone value with a predetermined threshold stored in a mask for binary output. In this case, the mask includes threshold values that are stored in memory. Thus, this method requires a separate storage device for storing threshold values.

In this case, how the threshold values are set has a great impact on image quality. Thus, to improve image quality, it is necessary to set various threshold values. To store various threshold values, this method requires a large-capacity memory, which increases the size of the storage device for storing threshold values. Furthermore, there are also many ways to perform color image halftoning using a mask. Using a separate mask for each color increases the size of the mask required for halftoning as the number of colors increases.

### SUMMARY OF THE INVENTION

The present invention provides a color image halftoning apparatus and method that can be applied to an image having a plurality of color channels using a single mask.

The present invention also provides an apparatus and method for generating a mask used in the color image halftoning apparatus and method.

According to an aspect of the present invention, there is provided an apparatus for halftoning a color image including: an address generator that receives a pixel in an image intended for halftoning and generates an address corresponding to the position of the pixel in a mask memory storing mask threshold values for one color channel; a mask generator that receives a mask threshold corresponding to the address from the mask memory and generates a mask threshold value for each of a plurality of color channels; and a comparison unit that sequentially receives the mask threshold value generated for each of the plurality of color channels and the pixel value in the image intended for halftoning, compares both values with each other, and outputs a bilevel value according to a predetermined rule.

The present invention also provides an apparatus for generating a mask during halftoning including: a mask information input unit that receives mask information for one color channel generated by a predetermined algorithm; an offset calculator that calculates a predetermined offset; and a mask calculator that calculates masks for a plurality of channels using information on the offset calculated by the offset calculator.

According to another aspect of the present invention, there is provided a method for halftoning a color image including the steps of: (a) receiving a pixel in an image intended for halftoning and generating an address corresponding to the position of the pixel in a mask memory storing mask threshold values for one color channel; (b) receiving a mask threshold value corresponding to the address from the mask memory and generating a mask threshold for each of a plurality of color channels; and (c) sequentially receiving the mask threshold value generated for each of the plurality of color channels and the pixel value in the image intended for halftoning, comparing both values with each other, and outputting a bilevel value according to a predetermined rule.

The present invention also provides a method for generating a mask during halftoning including the steps of: (a) receiving mask information for one color channel generated by a predetermined algorithm; (b) calculating a predetermined offset; and (c) calculating masks for a plurality of channels using information on the offset calculated in step (b).

According to yet another aspect of the present invention, there is provided a computer-readable recording medium that records a program for executing the above methods on a computer.

### BRIEF DESCRIPTION OF THE DRAWINGS

The above objects and advantages of the present invention will become more apparent by describing in detail illustrative, non-limiting embodiments thereof with reference to the attached drawings in which:

FIG. 1 explains a halftoning process;

FIG. 2 is an enlarged view of a bilevel image generated by halftoning;

FIG. 3 shows input and output bilevel images for explaining halftoning using a mask;

FIG. 4 shows the process of outputting a bilevel image using a mask;

FIG. 5 shows an 8×8 Bayer Dither Table;

FIG. 6A shows an image generated by frequency modulated (FM) dithering;

FIG. 6B shows an image generated by amplitude modulated (AM) dithering;

FIG. 6C shows the order in which dots are printed during AM dithering;

FIG. 7 is a block diagram of a halftoning apparatus applied to a single channel of color;

FIG. 8A illustrates a dot-on-dot halftoning technique;

FIG. 8B illustrates a shifted mask halftoning technique;

FIG. 8C illustrates an inverted mask halftoning technique;

FIG. 8D illustrates a three-mask halftoning technique;

FIG. 9 is a block diagram of a color image halftoning apparatus according to this invention;

FIG. 10 is a block diagram of a mask generation apparatus according to this invention;

FIG. 11 shows the fluctuations in a threshold value for each channel when a color image halftoning method of this invention is applied to a bilevel output device using three colors;

FIG. 12 shows the fluctuations in threshold values stored in the mask when a color image halftoning method of this invention is applied to a bilevel output device using four colors;

FIG. 13 is a flowchart illustrating a color image halftoning method according to this invention; and

FIG. 14 is a flowchart illustrating a mask generation method according to this method.

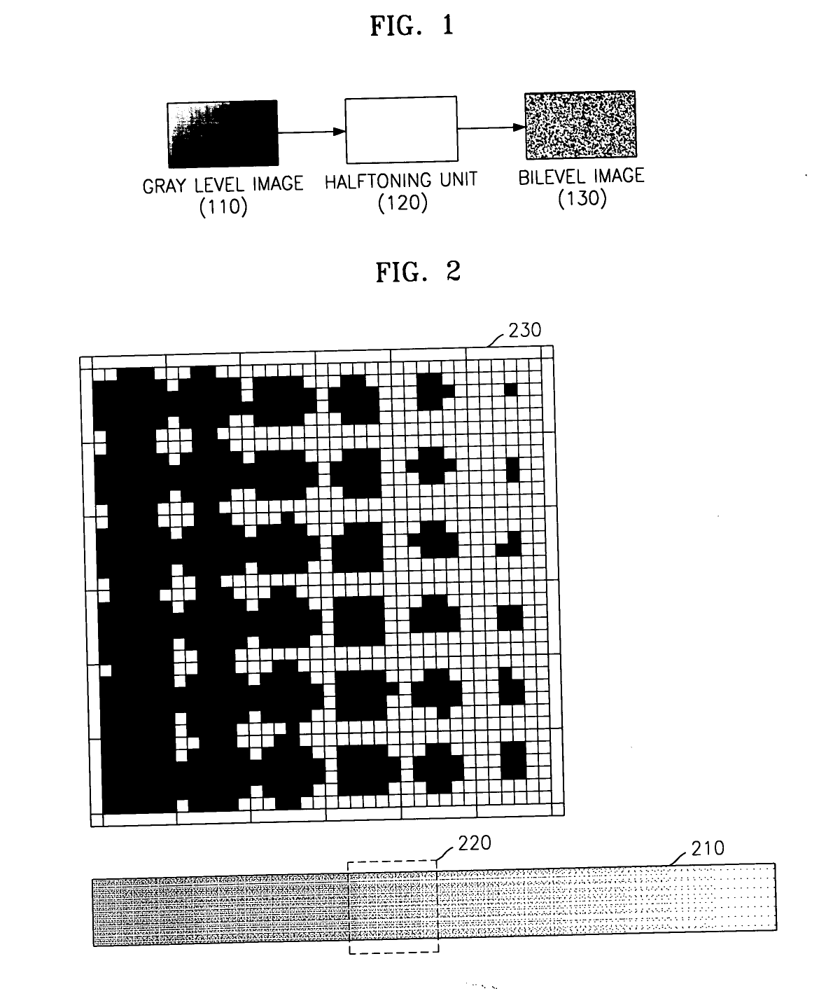

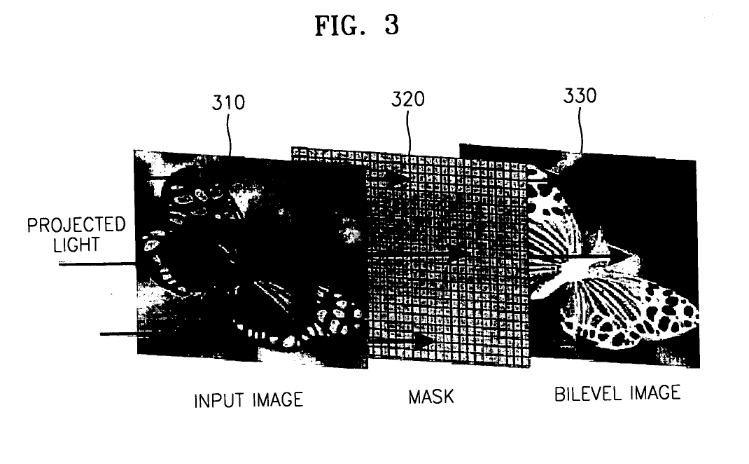

### DETAILED DESCRIPTION OF THE INVENTION

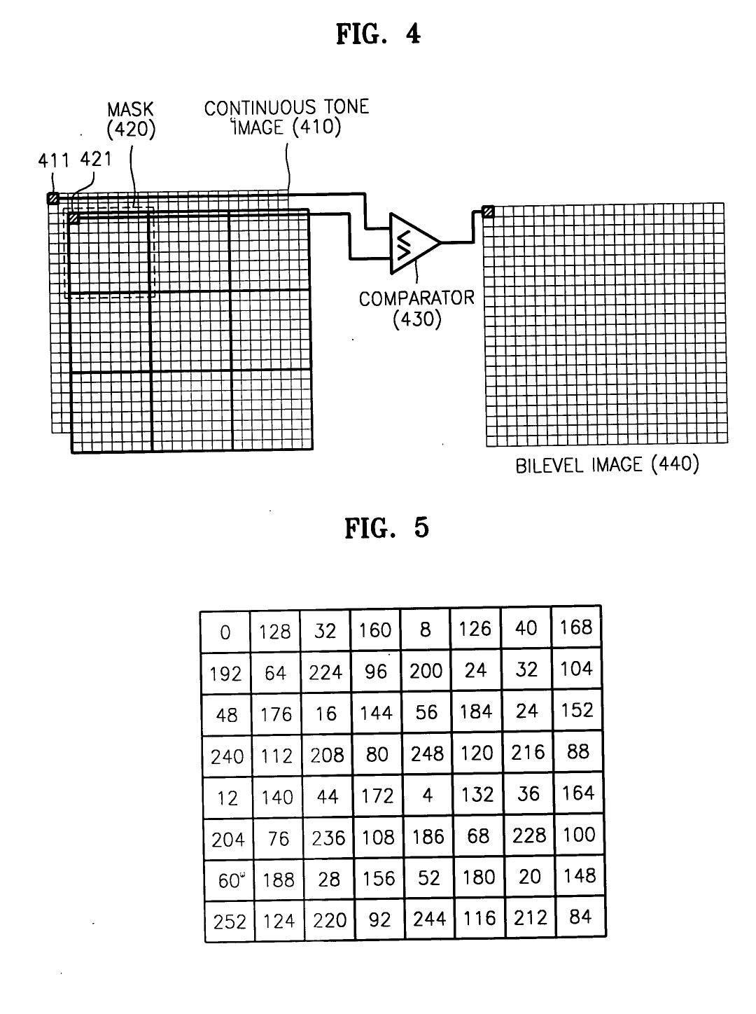

Referring to FIG. 4, halftoning is performed on a pixel-by-pixel basis. When a continuous tone image 410 is input, a first pixel value 411 and a first threshold value 421 stored in a predetermined size of a mask 420 are read and compared with each other by a comparator 430. An output value is then determined according to the comparison result. Similarly, a next pixel value and a next threshold value in the mask 420 are read and compared with each other. After performing the comparison on all pixels in this way, a bilevel image 440 is obtained. Threshold values stored in the mask 420 vary depending on the position of a pixel that is currently undergoing halftoning. Since the mask 420 is usually smaller than the input image 410, the same mask of a predetermined size is used repeatedly for halftoning. The size of the mask 420 may be set to various values, e.g., 4×4 or 8×8. Also, the threshold values stored in the mask 420 may be assigned using various algorithms.

FIG. 5 shows an 8×8 Bayer Dither Table. The Dither Table shown in FIG. 5 is created according to a Bayer's algorithm for assigning threshold values. In the table, close threshold values are dispersed as far as possible.

The quality of a generated bilevel image is affected by the current pixel value and arrangement of threshold values being compared. For example, if the threshold values are arranged regularly, the bilevel image is output in a regular pattern accordingly. If the threshold values contain white noise, i.e., high frequency components, the output bilevel image has an irregular pattern.

An illustrative, non-limiting embodiment will now be described around the examples of using a large mask that stores various threshold values in order to obtain improved image quality. When a larger mask is used, more threshold values can be stored in the mask and quantization error decreases, which results in a representation of the output bilevel image close to the original image. The regular patterns of the output bilevel image decrease so a large amount of memory is required for storing the threshold values in the mask.

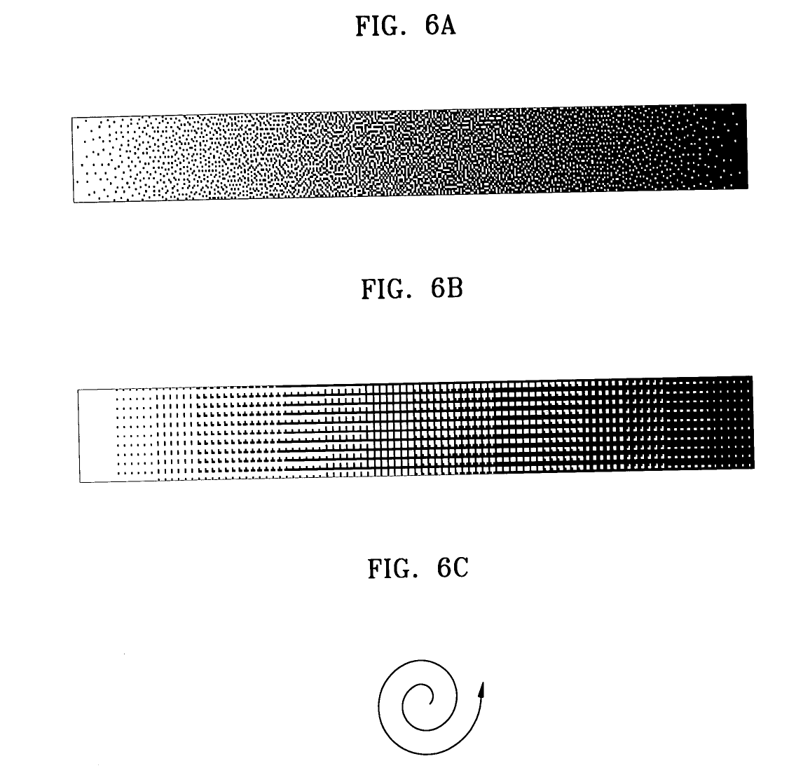

FIGS. 6A and 6B show images generated by frequency modulated (FM) dithering and amplitude modulated (AM) dithering, respectively, and FIG. 6C shows the order in which dots are printed during AM dithering.

While FM dithering represents a gray level image by small dots according to the resolution of the input image, AM dithering represents an image using the number or frequency of dots. When looking closely at FIG. 6B, dots are placed during AM dithering in a rotating order as is evident from FIG. 6C.

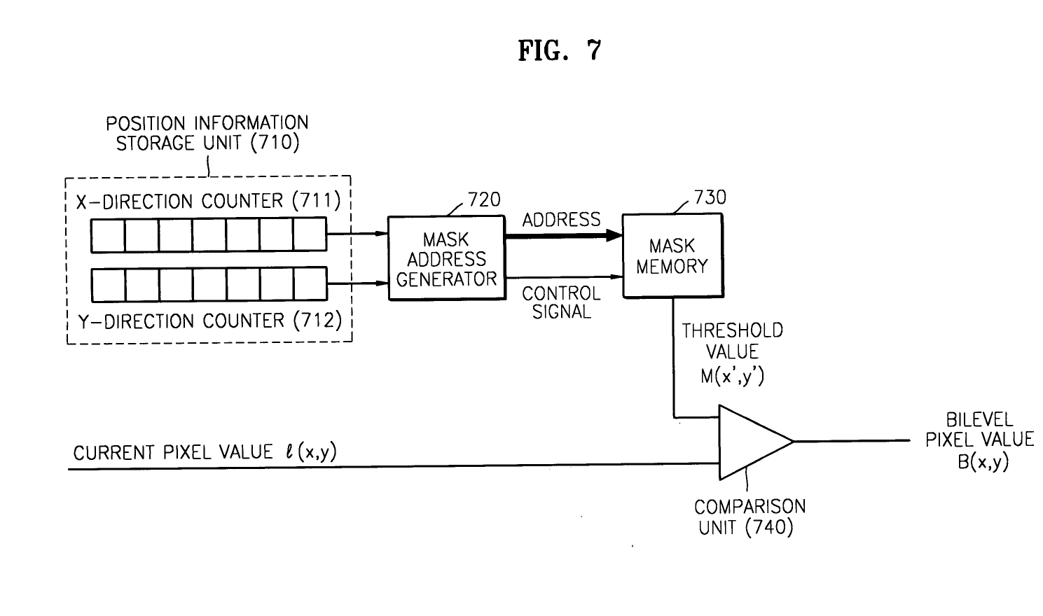

FIG. 7 is a block diagram of a halftoning apparatus applied to a single channel of color. Halftoning of a monochrome or black-and-white image will now be described with reference to FIG. 7. The position of a pixel in an input image is represented by two-dimensional (X, Y) coordinate pairs. Halftoning proceeds by sequentially reading each pixel from upper left to lower right. Since a threshold value corresponding to the position of pixel is read from the mask in order to perform halftoning on a pixel-by-pixel basis, the position of the current pixel that is undergoing halftoning needs to be identified.

A position information storage unit 710 stores the position of the current pixel undergoing halftoning. The position information storage unit 710 consists of X- and Y-direction counters 711 and 712 for counting X- and Y-coordinates of pixels, respectively. The size of each counter 711 or 712 is related to the size of the mask. If the mask size is 2N×2M, the counters 711 and 712 of the position information storage unit 710 are N- and M-bit memories. For example, if the mask size is 8×8, each of X- and Y-coordinate values can be represented by a 3-bit memory since the X- and Y-coordinate values are 1 through 8.

A mask address generator 720 reads X- and Y-coordinate values from the position information storage unit 710 and generates the corresponding address in a mask memory 730. For example, if the X- and Y-coordinate values of a pixel are 3 and 2 and the size of the mask memory 730 is 8×8, the pixel has coordinates (3, 2) and the corresponding address is set to No. 11. A control signal, which can be a read signal, is output with the address information thus created.

The mask memory 730 receives the address information and read signal from the mask address generator 720 and outputs a threshold value at a location corresponding to the address information. A comparison unit 740 receives the output threshold value and a continuous tone pixel value at the current location, compares both values with each other, and determines an output value according to a predetermined rule. The predetermined rule may require that one of both values is output after comparison or that another predefined value is output after comparison between both values.

A typical method of halftoning a color image involves breaking down the input image into color components such as (R, G, B), (C, M, Y), and (L, a*, b*), halftoning a continuous tone image comprised of three color components, and combining each bilevel image for output or mutually reflecting information on each channel during halftoning.

Furthermore, there are many ways for color image halftoning using a mask; a dot-on-dot scheme, which uses the same mask on different color components, a shifted mask scheme, which applies a mask with different threshold arrangement to each component, an inverted mask scheme, which applies one mask and its inverted mask generated by subtracting each threshold in the mask from a maximum threshold to create a new threshold arrangement, or three- or four-mask schemes that generate as many mutually exclusive masks as colors used for each channel.

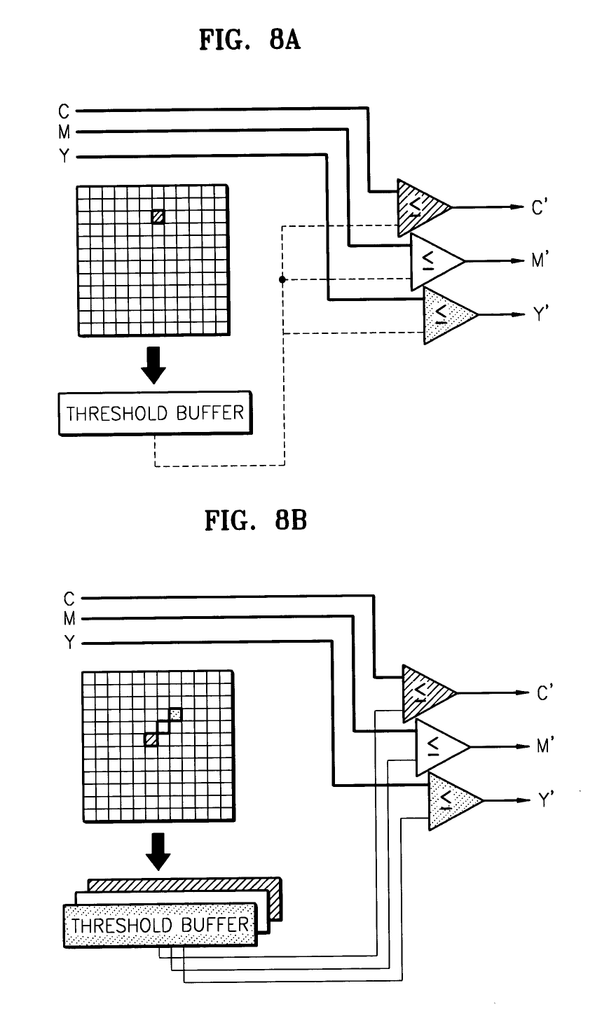

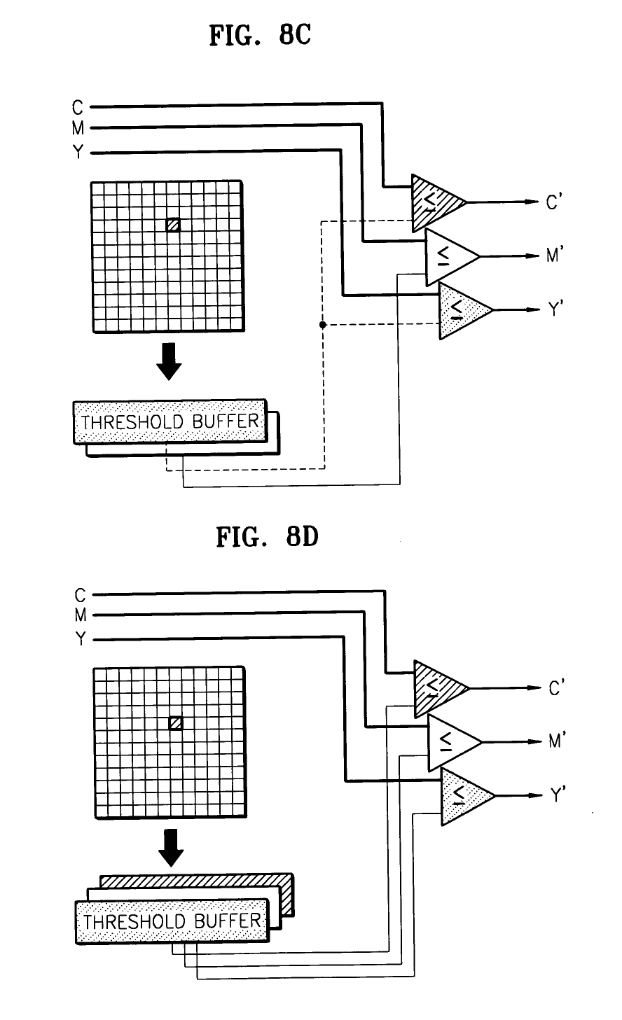

FIG. 8A shows a dot-on-dot halftoning technique. Although the dot-on-dot scheme is easiest to implement, this approach results in lowest spatial frequency and maximum luminance error in light regions since it uses the same threshold for a pixel in a color space.

FIG. 8B shows a shifted mask halftoning technique. In the shifted mask scheme, to decrease correlation between threshold values at the same location for each color, a new mask generated by entirely shifting the arrangement of threshold values is employed for halftoning each color component. Although the output bilevel image has high spatial frequency, the amount by which the threshold is shifted should be carefully chosen to remove the Moiré pattern.

FIG. 8C shows an inverted mask halftoning technique. The inverted mask scheme uses one mask for one color component and its inverted version generated by subtracting each threshold value from a maximum threshold value for another component. The bilevel image generated by this approach has high spatial frequency. While the inverted mask is typically used for two colors, i.e., cyan and magenta, an output value is determined in a way to reduce quantization error for the remaining yellow. This method may cause degradation in image quality when halftoning an image with a small number of colors.

FIG. 8D shows a three-mask halftoning technique. This three-mask scheme generates as many mutually exclusive masks as colors used for halftoning each channel. The output bilevel image has high spatial frequency. Since an independent mask is used for each color channel, this approach requires a large amount of memory for storing a plurality of masks. Similarly, if the number of channels is 4, this is also called a “four-mask scheme”.

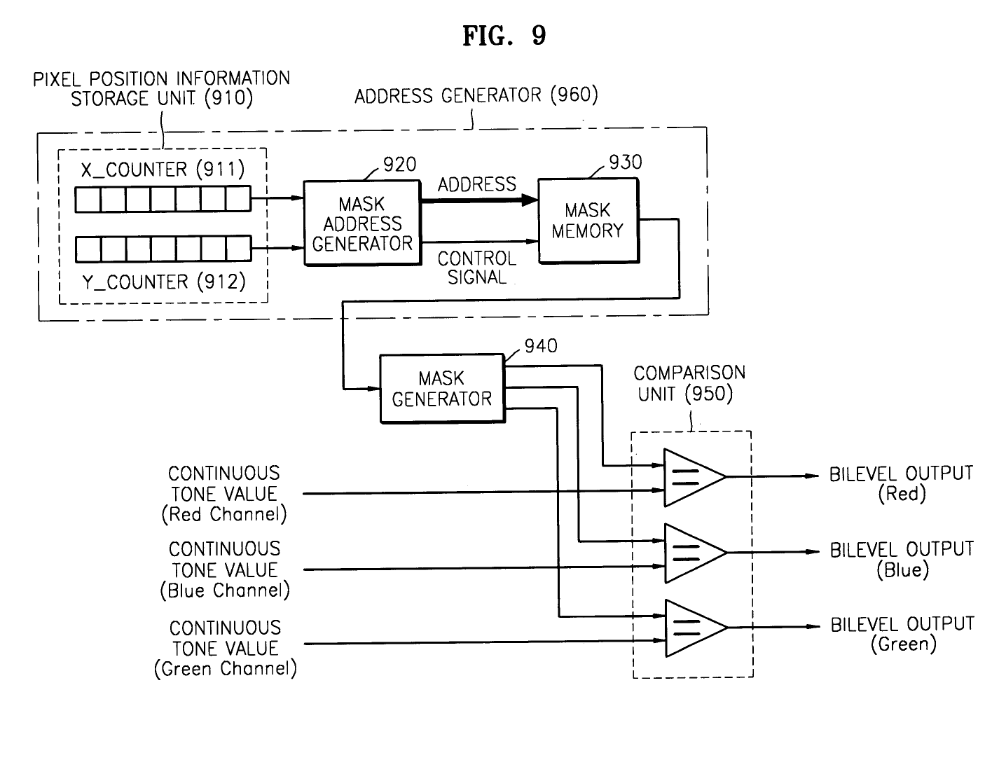

FIG. 9 is a block diagram of a color image halftoning apparatus according to the present invention. That is, the apparatus generates an arrangement in a mask containing various threshold values for each of a plurality of color channels using the same mask and performs halftoning for each color channel using the generated mask.

The color image halftoning apparatus of this invention is comprised of an address generator 960, a mask generator 940, and a comparison unit 950. The address generator 960 receives a pixel in an image intended for halftoning and generates an address corresponding to the position of the pixel in a mask memory 930 storing mask threshold values for one color channel.

The mask generator 940 receives a mask threshold corresponding to the address from the mask memory 930 and generates mask threshold values for each of a plurality of color channels.

The comparison unit 950 receives a threshold value and a continuous tone pixel value at the current location, compares both values with each other, and determines an output value according to a predetermined rule. The predetermined rule may require that one of both values will be output after comparison or that another predefined value will be output after comparison between both values.

The address generator 960 consists of a pixel position information storage unit 910, a mask memory 930, and a mask address generator 920.

The pixel position information storage unit 910 receives a pixel in an image intended for halftoning and stores the position of the pixel. The mask memory 930 stores mask threshold values for each color channel generated according to a predetermined algorithm. The example of threshold values generated according to a predetermined algorithm may be an 8×8 Bayer Dither Table. The mask memory 930 that has stored a mask representing threshold values for one color channel receives address information and a read signal and outputs a threshold value stored at a location corresponding to the address information.

The mask address generator 920 sequentially receives information about a pixel position from the pixel position information storage unit 910 and generates an address corresponding to the pixel position in the mask memory 930. For example, if X- and Y-coordinate values of a pixel are 3 and 2 and the size of the mask memory 930 is 8×8, the pixel has coordinates (3, 2) and the corresponding address is set to No. 11. A control signal, which can be a read signal, is output with the address information thus created.

Furthermore, the position information storage unit 910 consists of X_ and Y_ counters 911 and 912 for counting X- and Y-coordinates of pixels, respectively. The size of each counter 911 or 912 is related to the size of the mask. If the mask size is 2N×2M, the counters 911 and 912 of the position information storage unit 910 are N- and M-bit memories.

The mask generator 940 receives mask threshold values from the mask memory 930 and generates mask threshold values for each color channel. The method of generating the threshold values for each channel will be described later.

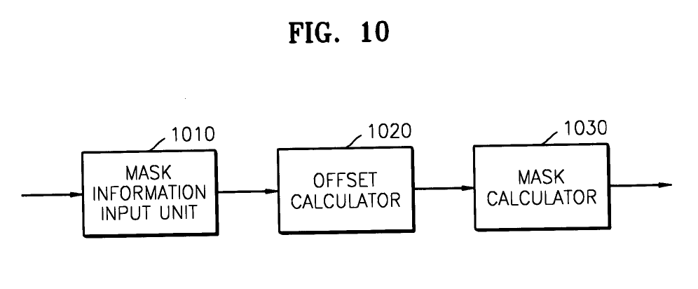

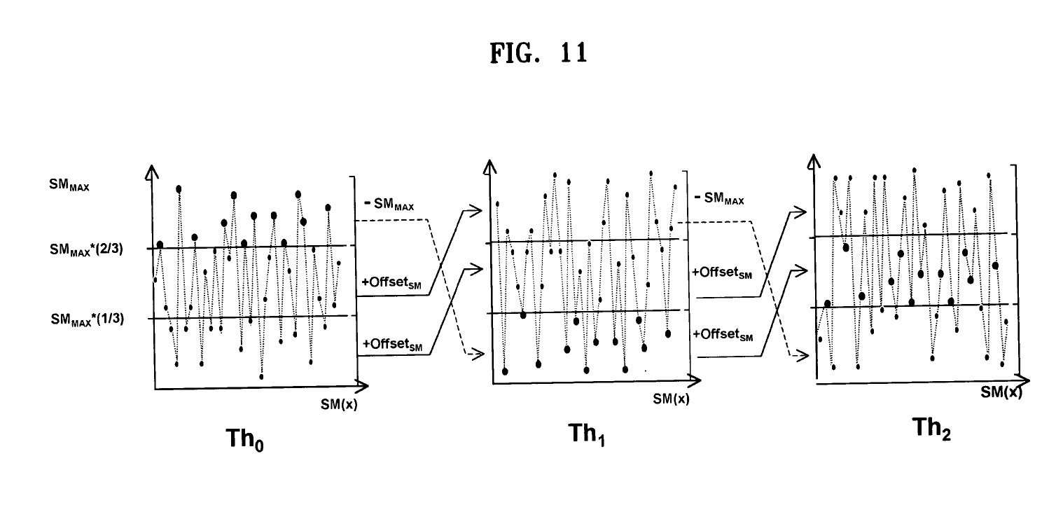

Referring to FIG. 10, the mask generator 940 includes a mask information input unit 1010 that receives threshold values stored in the mask memory 930, an offset calculator 1020 that calculates a predetermined offset, and a mask calculator 1030 that calculates masks for the plurality of channels using information on the offset calculated by the offset calculator 1020. Specifically, the offset calculator 1020 calculates the offset by dividing the largest pixel value in an image intended for halftoning by the number of colors used in the halftoning apparatus. The mask calculator 1030 receives a threshold value from the mask information input unit 1010, adds the offset calculated by the offset calculator 1020 to the threshold value, and if the resulting value is greater than the largest pixel value, calculates a threshold value by subtracting the largest pixel value from the resulting value.

The method of generating mask threshold values for each color channel will now be described in detail. First, Δoffset is calculated by dividing the largest pixel (tonal) value Ic by the number Nc of colors used. That is, Δoffset is defined by Equation (1). For example, assuming that a continuous tone value is represented by 8 bits and three colors are used, Δoffset equals 85(=256/3).

$$Δ offset = \frac{Ic}{Nc} \qquad ( 1 )$$

Then, each threshold value is calculated by a modular operator. The modular operator is defined by Equation (2):

Ω(a(x, y))=a(x, y) if a(x, y)<SMₘₐₓ a(x, y)−SMₘₐₓ if a(x, y)≧SMₘₐₓ (2)

Each threshold value is calculated by Equation (3) using the modular operator Ω:

Thₙ(x, y)=Ω(SM(x, y)+n·Δoffset) (3)

where SM(x, y) and n denote a mask value at coordinates (x, y) of a mask memory and the number of colors used in outputting a bilevel image. For example, assuming that mask threshold values corresponding to cyan, magenta, and yellow in a printer using the three colors are Th₀, Th₁, Th₂, respectively, each threshold is calculated by Equation (4):

Th₀(x, y)=Ω(SM(x, y)+0·Δoffset): Cyan

Th₁(x, y)=Ω(SM(x, y)+1·Δoffset): Magenta

Th₂(x, y)=Ω(SM(x, y)+2·Δoffset): Yellow (4)

The threshold values calculated using the above equations rotate based on the offset derived by dividing the largest pixel value by the number of colors that a bilevel output device can process. That is, Th₀ is output without an added offset, and Th₁ and Th₂ are output by adding the offset and double the offset to a mask value and performing modular operation, respectively.

FIG. 10 is a block diagram of a mask generation apparatus according to this invention. The mask generation apparatus is comprised of a mask information input unit 1010, an offset calculator 1020, and a mask calculator 1030. The mask information input unit 1010 receives mask information generated according to a predetermined algorithm for one color channel. The offset calculator 1020 calculates an offset by Equation (1), i.e., dividing the largest pixel value in an image intended for halftoning by the number of colors used for halftoning.

The mask calculator 1030 generates a mask for each channel using Equations (2)-(4) and offset information generated by the offset calculator 1020. That is, the mask calculator 1030 generates masks for a plurality of channels by receiving a threshold value from the mask information input unit 1010, adding the offset calculated by the offset calculator 1020 to the threshold, and if the resulting value is greater than the largest pixel value calculating a threshold value after subtracting the largest pixel value from the resulting value.

FIG. 11 shows the fluctuations in a threshold value for each channel when a color image halftoning method of this invention is applied to a bilevel output device using three colors. Since the quality of a bilevel image is determined depending on the threshold arrangement in each mask, it is not desirable for high quality output to impair the characteristics of the given threshold arrangement. This approach generates two or more masks by slightly adjusting the threshold arrangement with the offset while maintaining its original characteristics.

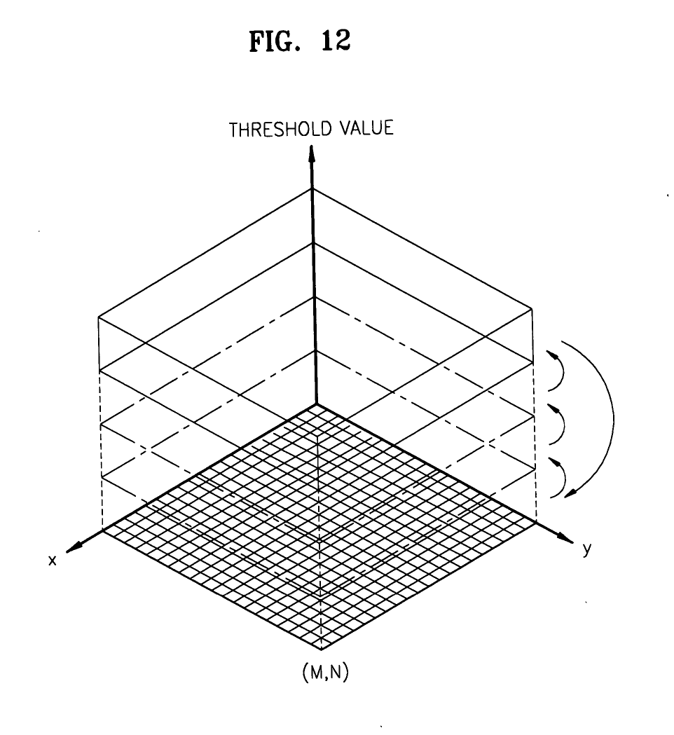

FIG. 12 shows the fluctuations in threshold values stored in the mask when a color image halftoning method of this invention is applied to a bilevel output device using four colors. That is, it shows changes in threshold values in a mask whose size is M×N and correlation between threshold values for each color. A vertical axis ranges from 0 through SMₘₐₓ and a horizontal axis indicates the location of the two-dimensional mask.

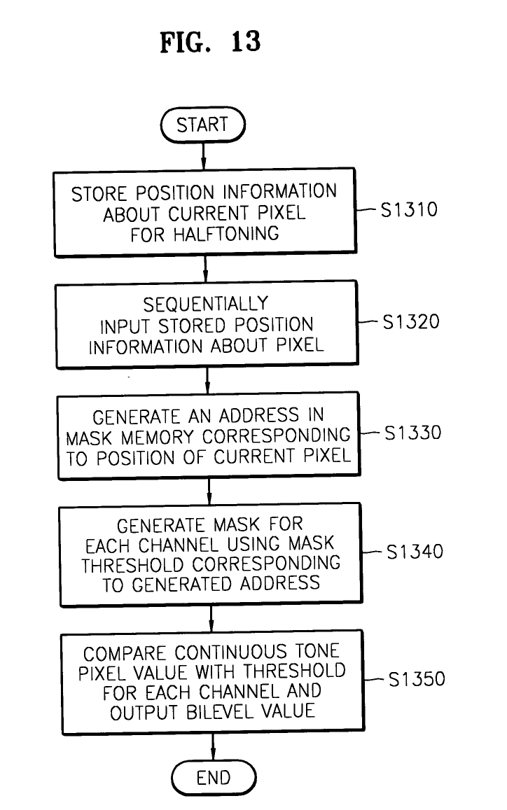

FIG. 13 is a flowchart illustrating a color image halftoning method according to this invention. In step S1310, a pixel in an image intended for halftoning is received and the position of the pixel is stored. Position information on the stored pixel is sequentially received in step S1320 and an address of the previously stored threshold in a mask memory corresponding to the pixel position stored in step S1310 is generated in step S1330. The mask memory may store an 8×8 Bayer Dither Table.

In step S1340, a mask threshold value corresponding to the generated address is received from the mask memory and the mask threshold values are generated for each of a plurality of color channels. In step 1350, the mask threshold value generated for each of the plurality of channels and a pixel value in an image intended for halftoning are sequentially received and compared with each other, and a bilevel value is output according to a predetermined rule.

The step of generating mask threshold values for each of the plurality of color channels will now be described in more detail. Threshold values stored in the mask memory are received, an offset is calculated by dividing the largest pixel value in an image intended for halftoning by the number of colors used in the halftoning apparatus, and masks for the plurality of color channels are calculated using the offset information. That is, in order to generate masks for the plurality of channels, the threshold values stored in the mask memory are received, the offset is added to the threshold value, and if the resulting value is greater than the largest pixel value in the image intended for halftoning, a threshold value is calculated by subtracting the largest pixel value from the resulting value.

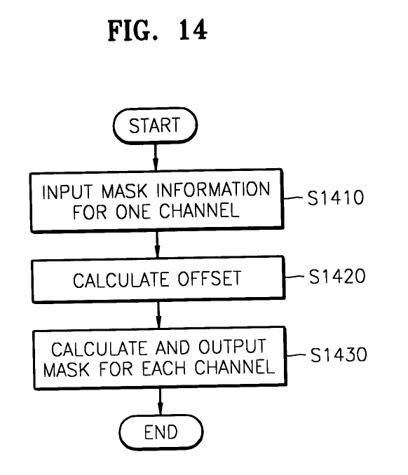

FIG. 14 is a flowchart illustrating a mask generation method according to this method. In step S1410, mask information for one color channel generated by a predetermined algorithm is received. In step S1420, an offset is calculated by dividing the largest pixel value in an image intended for halftoning by the number of colors used for halftoning. That is, the offset is calculated by Equation (1).

In step S1430, masks for a plurality of color channels are calculated using the offset information, i.e., Equations (2)-(4). Specifically, to generate masks for the plurality of channels, a threshold value stored in a mask memory is received, the offset calculated in step S1420 is added to the threshold value, and if the resulting value is greater than the largest pixel value in the image intended for halftoning, a threshold value is calculated by subtracting the largest pixel value from the resulting value.

Illustrative embodiments of the present invention can be written as a computer-readable code on a computer-readable recording medium. Examples of the computer-readable recording medium may include a ROM, a RAM, a CD-ROM, a magnetic tape, a floppy disk, and an optical data storage device. The code may also be transmitted in carrier waves e.g., via the Internet. Furthermore, the computer-readable code may be stored or executed on the recording media scattered on computer systems which are connected to one another by a network.

While this invention has been particularly shown and described with reference to illustrative, non-limiting embodiments thereof, it will be understood by those skilled in the art that various changes in form and details may be made therein without departing from the spirit and scope of the invention as defined by the appended claims. Therefore, the described embodiments should be considered not in terms of restriction but in terms of explanation. The scope of the present invention is limited not by the foregoing but by the following claims, and all differences within the range of equivalents thereof should be interpreted as being covered by the present invention.

As described above, a color image halftoning apparatus and method according to this invention have the following advantages over the conventional ones.

First, the apparatus and method of this invention, which are used in a device for outputting two or more colors, can increase spatial frequency compared to a conventional method by increasing or decreasing threshold values instead of changing the location in arrangement of those threshold values.

Second, although the halftoning method of this invention is similar to a conventional four-mask scheme, this invention has the advantage of reducing the memory size when manufacturing hardware components as well as accesses to the mask since it requires a single mask in a six-color color printer that currently becomes the most popular type of color output device. In general, as the resolution of a bilevel output device and the number of colors used therein increase, the size of a mask for bilevel image output and the number of masks for processing a color for each color channel increase. For these reasons, the conventional method increases a burden in terms of hardware. In contrast, this invention has the effect of reducing the mask size and image resolution.

Third, this invention, which is applied to a device for outputting three or more colors, can increase spatial frequency since there is low spatial correlation between threshold values at the same pixel position while decreasing luminance error compared to a conventional method using one mask. That is, this invention requires only a single mask for color printers using six or more ink colors, thereby reducing the memory size in fabricating hardware components while decreasing frequency of accesses to the memory for reading the arrangement of various threshold values. In addition, the operation for performing the halftoning method according to this invention requires only an adder, which imposes little burden on hardware installation.

Yet another advantage of this invention over a conventional art is to prevent degradation in image quality due to a change in threshold arrangement by creating a new threshold arrangement for a plurality of channels only with an offset value while maintaining the characteristics of the previous threshold arrangement.

What is claimed is:

1. An apparatus for halftoning a color image comprising:
an address generator that receives a pixel in an image intended for halftoning and generates an address corresponding to a position of the pixel in a mask memory storing mask threshold values for one color channel;
a mask generator that receives a respective stored mask threshold value corresponding to the address from the mask memory and generates a respective mask threshold value for each of a plurality of color channels; and
a comparison unit that sequentially receives the respective mask threshold value generated for each of the plurality of color channels and a pixel value in the image intended for halftoning, compares both values with each other, and outputs a bilevel value according to a predetermined rule.

2. The apparatus of claim 1, wherein the address generator comprises:
a pixel position information storage unit that receives the pixel in the image intended for halftoning and stores the position of the pixel;
a mask memory that stores mask threshold values for each color channel generated according to a predetermined algorithm; and
a mask address generator that sequentially receives information on the pixel position from the pixel position information storage unit and generates the address corresponding to the position in the mask memory.

3. The apparatus of claim 2, wherein the pixel position information storage unit comprises:
an X-direction counter that counts X-coordinates of pixels; and
a Y-direction counter that counts Y-coordinates of pixels.

4. The apparatus of claim 2, wherein the mask memory stores a Bayer Dither Table.

5. The apparatus of claim 4, wherein the mask memory stores an 8×8 Bayer Dither Table.

6. The apparatus of claim 1, wherein the mask generator comprises:
a mask information input unit that receives the respective stored mask threshold value from the mask memory;
an offset calculator that calculates a predetermined offset; and
a mask calculator that calculates the respective mask threshold value for each of the plurality of channels using information on the predetermined offset calculated by the offset calculator and the respective stored mask threshold value.

7. The apparatus of claim 6, wherein the offset calculator calculates the predetermined offset by dividing a largest pixel value in the image intended for halftoning by a number of colors used in the halftoning apparatus.

8. The apparatus of claim 6, wherein in order to generate the respective mask threshold value for each of the plurality of channels, the mask calculator receives the respective stored mask threshold value from the mask information input unit, adds the predetermined offset calculated by the offset calculator to the respective stored mask threshold value, and if a resulting value is greater than a largest pixel value, calculates the respective mask threshold value by subtracting the largest pixel value from the resulting value.

9. An apparatus for generating a mask during halftoning comprising:
a mask information input unit that receives mask information for one color channel generated by a predetermined algorithm;
an offset calculator that calculates a predetermined offset; and
a mask calculator that calculates masks for a plurality of channels using information on the predetermined offset calculated by the offset calculator.

10. The apparatus of claim 9, wherein the offset calculator calculates the predetermined offset by dividing a largest pixel value in an image intended for halftoning by a number of colors used for halftoning.

11. The apparatus of claim 9, wherein in order to generate the masks for the plurality of channels, the mask calculator receives a mask threshold value from the mask information input unit, adds the predetermined offset calculated by the offset calculator to the mask threshold value, and if a resulting value is greater than a largest pixel value, calculates a respective mask threshold value by subtracting the largest pixel value from the resulting value.

12. A method for halftoning a color image comprising the steps of:
(a) receiving a pixel in an image intended for halftoning and generating an address corresponding to a position of the pixel in a mask memory storing mask threshold values for one color channel;
(b) receiving a respective stored mask threshold value corresponding to the address from the mask memory and generating a respective mask threshold value for each of a plurality of color channels; and
(c) sequentially receiving the respective mask threshold value generated for each of the plurality of color channels and a pixel value in the image intended for halftoning, comparing both values with each other, and outputting a bilevel value according to a predetermined rule.

13. The method of claim 12, wherein the step (a) comprises the steps of:
(a1) storing in advance the respective stored mask threshold value for one color channel generated according to a predetermined algorithm;
(a2) receiving the pixel in the image intended for halftoning and storing the position of the pixel; and
(a3) sequentially receiving information on the pixel position stored in the step (a2) and generating the address of the respective stored mask threshold value in the mask memory corresponding to the position.

14. The method of claim 12, wherein the mask memory stores a Bayer Dither Table.

15. The method of claim 14, wherein the mask memory stores an 8×8 Bayer Dither Table.

16. The method of claim 12, wherein the step (b) comprises the steps of:
(b1) receiving the respective stored mask threshold value from the mask memory;
(b2) calculating a predetermined offset; and
(b3) calculating the respective mask threshold value for each of the plurality of channels using information on the predetermined offset calculated in the step (b2) and the respective stored mask threshold value.

17. The method of claim 16, wherein in the step (b2), the predetermined offset is calculated by dividing a largest pixel value in the image intended for halftoning by a number of colors used for the halftoning method.

18. The method of claim 16, wherein in the step (b3), the respective mask threshold value is generated for each of the plurality of channels by receiving the respective stored mask threshold value stored in the mask memory, adding the predetermined offset to the respective stored mask threshold value, and if a resulting value is greater than a largest pixel value, calculating the respective mask threshold value by subtracting the largest pixel value from the resulting value.

19. A method for generating a mask during halftoning comprising the steps of:
(a) receiving mask information for one color channel generated by a predetermined algorithm;
(b) calculating a predetermined offset; and
(c) calculating masks for a plurality of channels using information on the predetermined offset calculated in the step (b).

20. The method of claim 19, wherein in the step (b), the predetermined offset is calculated by dividing a largest pixel value in an image intended for halftoning by a number of colors used for the halftoning process.

21. The method of claim 19, wherein in the step (c), masks are generated for the plurality of channels by receiving threshold values stored in a mask memory, adding the predetermined offset to each threshold value, and if a resulting value is greater than a largest pixel value, calculating a respective threshold value after subtracting the largest pixel value from the resulting value.

22. A computer-readable recording medium that records a program for executing a color image halftoning method on a computer, the method comprising the steps of:
(a) receiving a pixel in an image intended for halftoning and generating an address corresponding to a position of the pixel in a mask memory storing mask threshold values for one color channel;
(b) receiving a respective stored mask threshold value corresponding to the address from the mask memory and generating a respective mask threshold value for each of a plurality of color channels; and
(c) sequentially receiving the respective mask threshold value generated for each of the plurality of color channels and a pixel value in the image intended for halftoning, comparing both values with each other, and outputting a bilevel value according to a predetermined rule.

23. A computer-readable recording medium that records a program for executing a mask generation method used during halftoning on a computer, the method comprising the steps of:
(a) receiving mask information for one color channel generated by a predetermined algorithm;
(b) calculating a predetermined offset; and
(c) calculating masks for a plurality of channels using information on the predetermined offset calculated in the step (b).
